(19) United States
(12) Patent Application Publication
(10) Pub. No.: US 2006/0260393 A1
(43) Pub. Date: Nov. 23, 2006

(54) LIQUID MEASURING DEVICE FOR WET TYPE IMAGE FORMING APPARATUS

(75) Inventors: Masatoshi Takano, Tokyo (JP); Hiroyuki Saito, Tokyo (JP); Hidetaka Yamaguchi, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/383,832

(22) Filed: May 17, 2006

(30) Foreign Application Priority Data
May 18, 2005 (JP) P2005145095

(51) Int. Cl. G01F 23/20

(52) U.S. Cl. 73/296

(57) ABSTRACT

A liquid measuring device to detect an amount of liquid contained in a container, having a weight detecting system to detect weight of the container including the liquid contained in the container, and an amount determining system configured to determine the amount of the liquid contained in the container based on the weight detected by the weight detecting system, is provided.

### BACKGROUND OF THE INVENTION

The present invention relates to a liquid measuring device for developing solution of a wet type image forming apparatus.

Apparatuses that transfer toner to a recording sheet to thereby form an image include, for example, a dry type image forming apparatus, which applies powder toner to a surface of a developing roller to form an image, and a wet type image forming apparatus, which applies developing solution containing toner in carrier solution to a surface of a developing roller to form an image. The toner employed in the latter apparatus is finer than that employed in the former. Accordingly, the latter provides an image of a higher quality.

A conventional wet type image forming apparatus is generally equipped with a developing solution container, and developing solution therein is supplied to a developing device during an image forming operation. In such a wet type image forming apparatus, color density of an image being formed depends on density of the toner in the developing solution. Therefore, in order to maintain the toner density to be constant, the developing solution is occasionally stirred and adjusted with additional carrier solution. Further, as the image is formed, an amount of the developing solution in the container decreases. Therefore, as disclosed in Registered Japanese Utility Model Publication No. 2556068, for example, the wet type image forming apparatus is provided with a liquid measuring unit for the developing solution so that the amount of the developing solution in the container is detected.

In the above-referenced publication, a liquid measuring unit with a liquid container, a frame that holds the container, and a platform that resiliently supports the frame is disclosed. The frame is adapted to be uplifted by expanding force of the platform according to weight of the container, and is provided with a sensor and a contacting member, which become in contact with each other when the frame is uplifted, and are released when the frame is depressed in an initial position with a substantial amount of liquid in the container. Thus, based on the contact of the sensor and the contacting member, the amount of the liquid in the container is detected. In this method, however, a level of merely one predetermined kind of liquid can be exclusively measured, and other kinds of liquid with different specific gravities cannot be measured.

In another example, a method to detect a level of the liquid in a container by having an object to be detected float on a surface of the liquid so that a level thereof is detected by a plurality of vertically aligned sensors is known. In many cases in this method, however, the object does not float properly when the developing solution adheres to a surface of the object. Further, when the developing solution is stirred in the container and a swirl occurs, the level of the liquid may not accurately be detected. Moreover, in this method, a plurality of sensors for each of the levels to be detected are required, therefore the measuring unit tends to be greater in size as the number of the detection levels increases.

### SUMMARY OF THE INVENTION

In view of the foregoing drawbacks, the present invention is advantageous in that an improved liquid measuring device for developing solution, which is capable of accurately detecting an amount of the developing solution is provided.

According to an aspect of the invention, there is provided a liquid measuring device to detect an amount of liquid contained in a container, having a weight detecting system to detect weight of the container including the liquid contained in the container, and an amount determining system configured to determine the amount of the liquid contained in the container based on the weight detected by the weight detecting system.

Optionally, the weight detecting system may include a guide member allowing the container to be shifted in vertical directions so that the container is restricted in moving in directions other than the vertical directions, and a weight sensor to resiliently hold the container and to sense the weight of the container including the liquid contained in the container.

According to another aspect of the invention, there is provided a liquid containing unit, including a liquid measuring device, which is adapted to detect an amount of liquid contained in a container, with a weight detecting system to detect weight of the container including the liquid contained in the container, and an amount determining system configured to determine the amount of the liquid contained in the container based on the weight detected by the weight detecting system.

Optionally, the weight detecting system may include a guide member allowing the container to be shifted in vertical directions so that the container is restricted in moving in directions other than the vertical directions, and a weight sensor to resiliently hold the container and to sense the weight of the container including the liquid contained in the container.

Optionally, the liquid containing unit may further include a stirring system, which is adapted to stir the liquid contained in the container.

Optionally, the stirring unit may include a screw to be rotated by a motor so that the liquid contained in the container is stirred thereby.

Optionally, the stirring system may be fixed to a mechanism being provided independently from the container.

Optionally, the motor may be activated at predetermined intervals.

Optionally, the amount of the liquid contained in the container may be detected whilst the motor is inactive.

Optionally, the stirring system may be located integrally with the container.

Optionally, the amount of the liquid contained in the container is detected whilst the motor is inactive.

According to another aspect of the invention, there is provided a wet type image forming appratus, including a liquid measuring device to detect an amount of developing solution contained in a container, with a weight detecting system to detect weight of the container including the developing solution contained in the container, and an amount determining system configured to determine the amount of the liquid contained in the container based on the weight detected by the weight detecting system.

According to another aspect of the invention, there is provided a wet type image forming apparatus, including a liquid containing unit with a liquid measuring device, which is adapted to detect an amount of developing solution contained in a container and has a weight detecting system to detect weight of the container including the developing solution contained in the container, an amount determining system configured to determine the amount of the liquid contained in the container based on the weight detected by the weight detecting system,

### BRIEF DESCRIPTION OF THE ACCOMPANYING DRAWINGS

FIG. 1 is a cross-sectional side view showing a structure of a wet type printer according to an embodiment of the present invention.

FIG. 2 is another cross-sectional side view of the wet type printer taken from a rear side thereof according to the embodiment of the present invention.

FIG. 3 is an illustrative diagram of a solution container of the wet type printer according to the embodiment of the present invention.

FIG. 4 is a flowchart to illustrate a developing solution supplying process to adjust a liquid level in the solution container according to the embodiment of the present invention.

### DETAILED DESCRIPTION OF THE EMBODIMENTS

Referring to the accompanying drawings, a wet type printer according to an embodiment of the present invention will be described in detail.

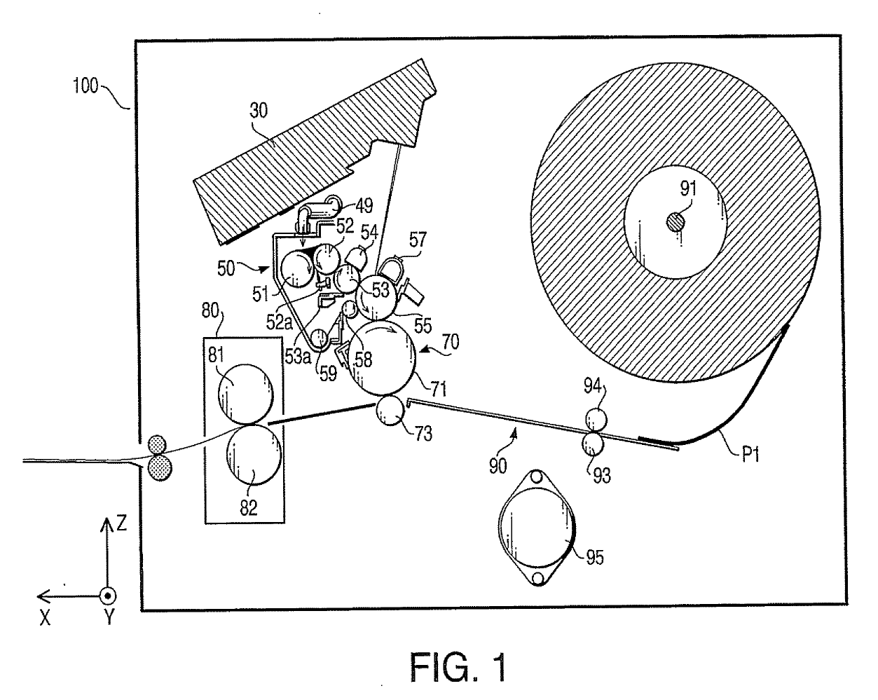

FIG. 1 is a cross-sectional side view showing a structure of a wet type printer 100 according to an embodiment of the present invention. The wet type printer 100 in the present embodiment is an apparatus that receives print information (i.e., character and/or image information) from an external apparatus such as a computer, and prints out the characters or the images on a sheet of recording paper P1 in accordance with a so-called electrophotographic imaging process by using developing solution with carrier solution and toner therein.

The wet type printer 100 includes a laser scanning unit (hereinafter abbreviated as “LSU”) 30 that outputs a laser beam modulated according to the print information, a developing unit 50 that develops a latent image formed on a photoconductive drum 55 according to the print information with the developing solution in the electrophotographic method, a feeding unit 90 that feeds the recording paper P1, a transfer unit 70 that transfers a toner image developed by the developing unit 50 at a transfer position onto the recording paper P1, and a fixing unit 80 that permanently fixes the toner image that has been transferred on the recording paper P1.

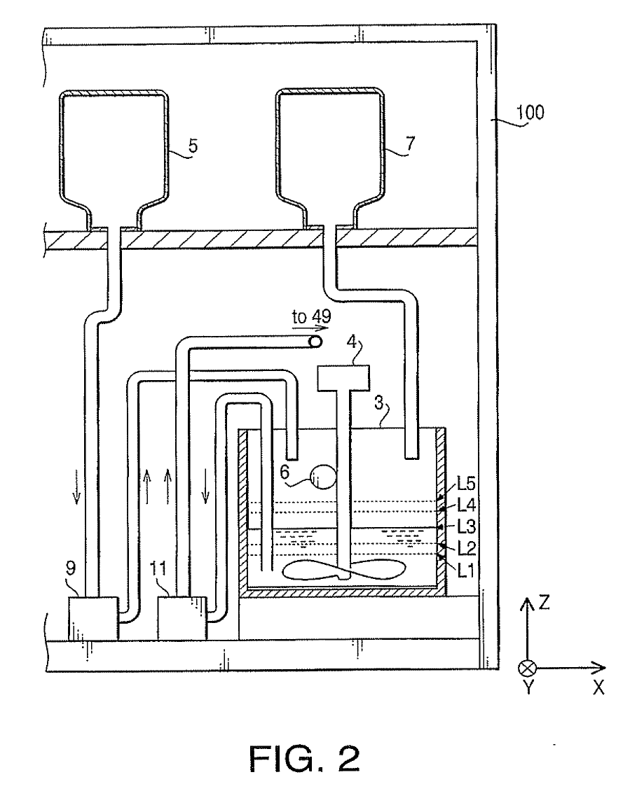

The developing unit 50 includes an add roller 51, a measuring roller 52, an adjusting blade 52a, a developing roller 53, a developing roller cleaning blade 53a, a developing roller corona charger 54, the photoconductive drum 55, a photoconductive drum corona charger 57, a solution pipe 49, and a screw 59. The measuring roller 52 is provided to measure an amount of the developing solution on a surface thereof. The adjusting blade 52a evenly adjusts thickness of the developing solution on the surface of the measuring roller 52. The developing roller 53 carries the developing solution supplied from the measuring roller 52. The developing roller cleaning blade 53a scrapes off an excessive amount of the developing solution from the surface of the developing roller 53. The developing roller corona charger 54 charges the surface of the developing roller 53. A surface of the photoconductive drum 55 has a latent image formed by the laser beam from the LSU 30. The photoconductive drum corona charger 57 uniformly charges the surface of the photoconductive drum 55. The squeeze roller 58 collects used developing solution from the surface of the photoconductive drum 55. And the screw 59 transmits residual developing solution collected in the developing unit 50 to a solution container 3 (see FIG. 2). All of rotation axes of the respective rollers are in parallel with each other and are perpendicular to a direction parallel to a plane of FIG. 1, although rotating directions of the respective rollers may vary.

When the image is formed, the developing solution stored in the solution container 3 is injected and the injected developing solution is transitionally pooled in a pit portion formed by the add roller 51 that rotates in a clockwise direction in FIG. 1 and the measuring roller 52 that rotates in a counterclockwise direction in FIG. 1. Thereafter, the developing solution is supplied to a surface of the measuring roller 52 by the rotation of the measuring roller 52. The supplied developing solution is partially scraped off and thereby adjusted by the adjusting blade 52a, of which an edge is in contact with the surface of the measuring roller 52 so that excessive amount of the developing solution is removed. Thus, the remaining developing solution on the surface of the measuring roller 52 is transferred evenly to a surface of the developing roller 53, which is in contact with the measuring roller 52. The photoconductive drum 55 has the surface constituted of a conductive material, so that such surface is uniformly charged by a corona charging effect of the developing roller corona charger 57. On the surface of the photoconductive drum 55, a latent image corresponding to the print information is formed, by the laser beam emitted from the LSU 30. The photoconductive drum 55 is charged so as to gain a higher potential than that of the developing roller 53, by the photoconductive drum corona charger 57. However, the region where the latent image is formed gains a lower potential than the developing roller 53, due to an effect of the laser beam. Accordingly, between the region excluding the latent image on the photoconductive drum 55 and the surface of the developing roller 53, the toner remains closely stuck to the lower-potential region, i.e. the surface of the developing roller 53, without being transferred to the region where no latent image exists. Consequently, the region excluding the latent image is not developed. By contrast, between the latent image region on the surface of the photoconductive drum 55 and the surface of the developing roller 53, the toner performs electrophoresis toward the lower-potential region, i.e. the latent image region on the surface of the photoconductive drum 55, thus to adhere thereto. That is how the latent image on the photoconductive drum 55 is developed, to turn into a toner image.

The toner image developed on the surface of the photoconductive drum 55 is transferred to the recording paper P1 by the transfer unit 70. The transfer unit 70 includes an intermediate transfer roller 71 and a secondary transfer roller 73. To the intermediate transfer roller 71, a transfer bias of a reverse polarity to the toner is applied, so that the toner image developed on the surface of the photoconductive drum 55 is transferred as a primary step to the intermediate transfer roller 71, at the interface between the photoconductive drum 55 and the intermediate transfer roller 71. The intermediate transfer roller 71 and the secondary transfer roller 73 are disposed so as to be opposed to each other across a paper path for the recording paper P1, and mutually abut at a predetermined nip pressure. The toner image transferred to the surface of the intermediate transfer roller 71 is transferred to the recording paper P1 being carried along the paper path at the interface with the secondary transfer roller 73, by the effect of a transfer electric field, the nip pressure and so on.

The recording paper P1 on which the toner image has been transferred is carried to the fixing unit 80 along the paper path. The fixing unit 80 serves to apply heat and pressure to the recording paper P1, so as to fix the toner image onto the recording paper P1, and includes a heat roller 81 that heats up the recording paper P1, and a press roller 82 located opposite to the heat roller 81 across the paper path, so as to hold the recording paper P1 in cooperation with the heat roller 81, thus to apply a pressure to the recording paper P1.

The feeding unit 90 includes a core roller 91, around which the recording paper P1 as a continuous form recording sheet is rolled, a feed roller 93, which carries the recording paper P1, a subsidiary feed roller 94, which is rolled accordingly to rotation of the feed roller 93 to carry the recording paper P1, and a drive motor 95, which supplies rotating force to the feed roller 93.

Next, referring to FIG. 2, the solution container 3, to store the developing solution therein will be described. The wet type printer 100 in the present embodiment includes the solution container 3, wherein the developing solution is stored, a preparatory solution container 5, a preparatory carrier solution container 7, a supplier pump unit 9, and a conveyer pump unit 11. The preparatory solution container 5 stores therein preparatory developing solution, which is supplied to the solution container. Carrier solution is stored in the preparatory carrier solution container 7, and is supplied to the solution container 3. The supplier pump unit 9 is used to transmit the preparatory developing solution in the preparatory solution container 5 to the solution container 3.

During a printing operation of the wet type printer 100, the developing solution in the solution container 3 is conveyed to the developing unit 50 by the conveyer pump unit 11. An outlet of the conveyer pump unit 11 is connected to the solution pipe 49. When the level of the developing solution in the solution container 3 becomes too low, the developing solution is not supplied to the developing unit 50. Therefore, in the present embodiment, the preparatory developing solution stored in the preparatory solution container 5 is supplied to the solution container 3 when the level of the developing solution in the solution container becomes as low as a predetermined lower limit. Further, toner density of the developing solution in the solution container 3 tends to be concentrated over image forming operations. Therefore, the toner density is monitored by a density sensor (not shown) so that the carrier solution is supplied from the preparatory carrier solution container 7 if necessary.

As mentioned above, color density of an image to be formed depends on toner density of the developing solution. That is, the image is printed in higher density when the toner density of the developing solution is high, and in lower density when the toner density is low. In the wet type printer 100 in the present embodiment, the toner density in the developing solution in the solution container 3 is adjusted with the supplemental carrier solution from the preparatory carrier solution container 7 so that the toner density (i.e., the color density of the image) is maintained constant. More specifically, the developing solution in the solution container 3, as well as the developing solution in the preparatory solution container, is composed in a weight ratio of approximately 30% as toner and the remaining 70% as carrier solution.

As viscosity of the developing solution is generally high, in order to avoid coagulation, the developing solution requires occasional stirring so that fluidity of the developing solution is maintained. The solution container 3 is provided with a stirring unit 4, which stirs the stored developing solution, and a lateral opening 6. The lateral opening 6 is connected to a pipe (not shown), which is further connected to an opening (not shown) provided on an extended line (not shown) of an axis of the screw 59 (see FIG. 1). The developing solution carried by the screw 59 is returned to the solution container 3 via the lateral opening 6.

When a level of the developing solution in the solution container 3 is as low as or lower than a level L1 shown in FIG. 2, a substantial amount of the developing solution may not be supplied to the developing unit 50. As the amount of the developing solution decreases and when the level of the developing solution reaches to a level L2, a predetermined amount of supplemental developing solution is added to the developing solution in the solution container 3. That is, the level L2 is a threshold to determine whether the supplemental developing solution should be added to the solution container 3. A level L3 of the developing solution indicates an average level of the developing solution when the amount of the developing solution is adjusted. In a normal operation of the wet type printer 100, it is preferable that the level of the developing solution is maintained in a range from the level L2 to a level L4. It should be noted that a level L5 indicates that the developing solution is excessive and the developing solution may overflow during the normal operation.

As mentioned above, the used developing solution that is residual from the developing unit 50 is returned to the solution container 3 by the screw 59. Thus, the amount of the developing solution in the solution container 3 decreases during the printing operation of the wet type printer 100, whilst the toner density therein increases gradually. Therefore, the toner density is monitored by a density sensor (not shown) so that the carrier solution is supplied from the preparatory carrier solution container 7 if necessary.

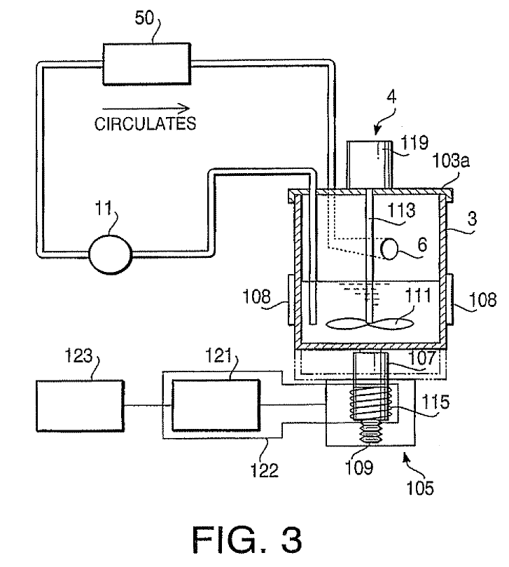

FIG. 3 is an illustrative diagram of the solution container 3 of the wet type printer 100 according to the embodiment of the present invention. The solution container 3 is formed to be, for example, cylindrical with a bottom thereof being closed and a top thereof being open. On top of the solution container 3, a cover 103a is provided. A stirrer unit 4 and a weight sensor unit 110 are provided in a vicinity to the solution container 3. The stirrer unit 4 includes a drive motor 119, a stirrer 111, and a rotary shaft 113. The stirrer 111, for example a screw, is adapted to stir the developing solution by rotating. The rotary shaft 113 is coupled to the drive motor 119 at one end, and is coupled to the stirrer 111 at the other end, so that rotating force of the drive motor 119 is transmitted to the stirrer 111. The drive motor 119 is fixed to a top of the cover 103a, which is fixed to a body of the wet type printer 100. The drive motor 119 is activated when the developing solution is stirred, and as the stirrer 111 is rotated by the rotating force of the drive motor, the developing solution is stirred.

On a circumferential surface of the solution container 3, a guide member 108 is provided. The guide member 108 is fixed to the body of the wet type printer 100, and is configured to guide the solution container 3 to be shifted only in vertical directions, which is perpendicular to the surface of the developing solution in the solution container 3. The guide member 108, for example, may be provided with a plurality of bearings on an inner circumference thereof, so that the bearings may be engaged with grooves extended vertically on the circumferential surface of the container 3. (It should be noted that the grooves may be provided to the circumferential surface of the container 3 if the guide member 108 is configured to have the bearings.) In this configuration, the solution container 3 is allowed to be shifted vertically, whilst the solution container 3 is restricted from rotating in circumferential directions.

The weight sensor unit 105 is configured to support the solution container 3 from the bottom. The weight sensor unit 105 may include, for example, a known weight sensor with an LC resonant circuit. The weight sensor unit 105 in the present embodiment includes a pushrod 107, a spring 109, the LC resonant circuit 122 with a coil 115 (the LC resonant circuit 122 excluding the coil 115 is referred to as an LC resonant circuit 121), and a solution amount detecting unit 123. The pushrod 107, which is in contact with the bottom surface of the solution container, is formed to be cylindrical, and is adapted to be shifted vertically according to weight of the solution container. The spring 109 is adapted to apply an expanding force to the pushrod so that the pushrod 107 is pressed against the bottom surface of the solution container 3. The coil 115, as an inductance component L of the LC resonant circuit, is arranged around a lower portion of the pushrod 107. The solution amount detecting unit 123 is adapted to judge the amount of the developing solution in the solution container 3 based on a resonant frequency of current obtained from the LC resonant circuit 122. The solution amount detecting unit 123 is further adapted to control power supply to the supplier pump 9 based on the amount of the developing solution detected, so that the preparatory developing solution is supplied to the solution container 3 when required.

The pushrod 107 is adapted to be shifted vertically according to transition of the weight of the solution container 3, which decreases as the developing solution therein is used during the printing operation, and increases as the supplemental developing solution is added. A lower portion of the pushrod 107 is made of, for example, a ferromagnetic material, so that the inductance of the coil 115 is altered according to the vertical movement of the pushrod 107, and thus the resonant frequency of the LC resonant circuit 122 is altered.

In the above-described configuration of the present embodiment, the weight of the solution container 3 with the developing solution therein is proportional to the resonant frequency of the current output from the LC resonant circuit 122. That is, the weight of the solution container 3 including the developing solution can be obtained from the resonant frequency of the current from the LC resonant circuit 122. As described above, the toner density of the developing solution in the solution container 3 is maintained to be substantially constant. Therefore, with a specific gravity corresponding to the density of the developing solution and the weight of the developing solution in the solution container 3 (obtained by subtracting weight of the solution container 3 from the total weight of the solution container 3 including the developing solution), the amount (i.e., a volume) of the developing solution in the solution container 3 can be detected. It should be noted that the weight sensor unit is not limited to a sensor unit with an LC resonant circuit as described above, but may be any weight sensor unit, for example using a strain gauge, as long as the weight sensor unit is capable of holding and measuring weight of the solution container 3.

It should be noted that, in the measuring unit with the weight sensor unit 105 as described above, the weight sensor unit 105 is prevented from being in contact with the developing solution in the solution container 3 even when the amount of the developing solution is measured. Therefore, the measuring accuracy of the weight sensor unit 105 will not be affected by the high viscosity of the developing solution, as the developing solution will not adhere to the weight sensor unit 105. Further, as the measuring is based on the weight of the developing solution in the solution container 3, the weight sensor unit 105 can avoid measuring erroneously the surface level of the developing solution that may be unevenly fluctuated due to the high viscosity thereof during a stirring operation. It should be further noted that, with the weight sensor unit 105, different kinds of developing solutions with different specific gravities can be measured. When an interrelation between weight of the solution container 3 including developing solution and an amount (i.e., a volume) of the developing solution to be included in the solution container 3 is defined, i.e., when a specific gravity for each kind of the developing solution to be used is defined, the amount of the developing solution can be accurately measured by the same weight sensor unit 105 regardless of the difference in specific gravities of developing solution. Thus, the wet type printer 100 can be configured in a more simplified design. Furthermore, as the weight sensor unit 105 does not require a sensor and the like to be arranged on top of the solution container 3 and other peripheral space, the wet type printer 100 can be downsized.

In the present embodiment, the weight sensor unit 105 is adapted to measure the amount of the developing solution whilst the developing solution is maintained still and the drive motor 119 of the stirrer unit 4 is inactivated, as the developing solution may be fluctuated vertically by external force from the stirrer 111 when the drive motor 119 is activated and the stirrer 111 is rotated. The stirrer unit 4 is activated and stirs the developing solution at predetermined intervals of time. Therefore, the weight of the solution container 3 including the developing solution is measured whilst the stirrer 111 is motionless, so that the amount of developing solution can be accurately measured. More specifically, for example, the drive motor 119 may be controlled to be activated at the predetermined interval.

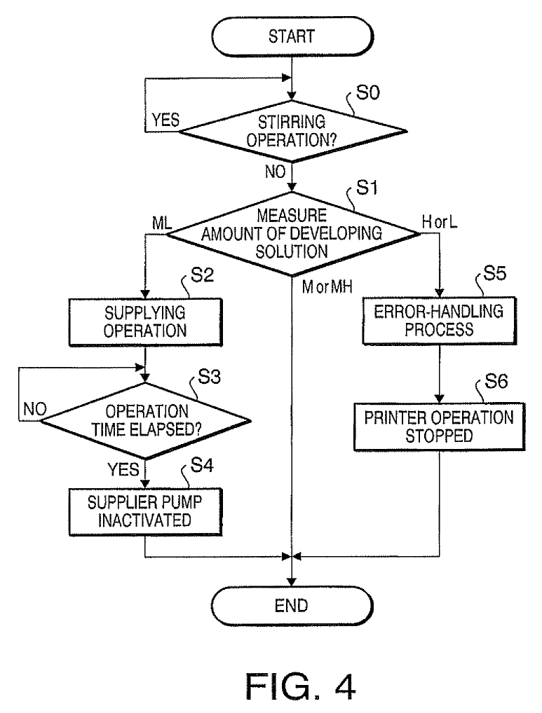

Next, referring to FIG. 4, a developing solution supplying process to adjust the level of the developing solution in the solution container 3 according to the embodiment of the present invention will be described. In the developing solution supplying process, the supplemental developing solution is added when the amount of the developing solution measured is less than a predetermined level, whilst an error-handling process is conducted when the measured amount is over a predetermined level, The developing solution supplying process shown in FIG. 4 is repeatedly executed by a control unit (not shown) at a predetermined interval during a normal operation of the wet type printer 100. As the developing solution supplying process starts, the control unit examines whether the stirrer unit 4 is in a stirring operation (S0). When the stirrer unit 4 is not in the stirring operation (S0: NO), the weight sensor unit 105 measures the amount of the developing solution in the solution container 3 (S1). When the measured amount indicates that the surface level of the developing solution is in a range from the level L1 to the level L2 (more specifically, higher than the level L1 and lower than or equal to the level L2) (S1: ML), the amount of the developing solution in the solution container 3 is considered to be low, and the process proceeds to S2. In S2, the control unit activates the supplier pump 9 to supply the supplemental developing solution to the solution container 3. As an amount of the developing solution to be supplied by the supplier pump 9 in a unit of time is constant, operation time of the supplier pump 9 is set based on the amount of the developing solution before the supplying operation (i.e., the measured amount). When the operation time elapses (S3: YES), the control unit inactivates the supplier pump 9 (S4). Thereafter, the process ends.

When the measured amount of the developing solution indicates that the surface level is in a range from the level L4 to the level L2 (more specifically, the surface level is lower than the level L4 and higher than the level L2) (S1: d), and when the measured amount indicates the surface level is lower than the level L5 and higher than or equal to the level L4 (S1: MH), the process ends, as the amount is in a preferable level.

When the measured amount of the developing solution indicates that the surface level is higher than or equal to the level L5 (S1: H), and when the surface level is lower than or equal to the level L1 (S1: L), the control unit executes the error-handling process, in which for example a notification is given to a user by generating an error sound and/or by displaying an error-notifying message (S5), and the control unit stops the operation of the wet type printer 100 (S6).

Although the present invention has been described based on the foregoing embodiment, it is to be understood that the present invention is not limited thereto, but various modifications may be made without departing from the scope of the present invention.

For example, the cover 103a may have the stirrer unit 4 thereon and may be fixed to the solution container 3, instead of having the stirrer unit 4 fixed to the cover 103a that is fixed to the body of the wet type printer 100. In this configuration, weight to be measured by the weight sensor unit 105 is a sum of the solution container 3 with the developing solution, the cover 103a, and the stirrer unit 4. Therefore, when the amount of the developing solution is measured, the weight of the developing solution is obtained by subtracting the weight of the solution container 3, the cover 103a, and the stirrer unit 4 from the sum. It should be noted in this configuration that the weight of the developing solution does not change even when the developing solution is fluctuated vertically by rotation of the stirrer 111. Therefore, the step S0 in the developing solution supplying process can be omitted.

As described above, with the weight sensor unit 105 of the wet type printer 100, the amount of the developing solution in the solution container 3 can be accurately measured as the weight sensor unit 105 is not affected by the developing solution. Further, different kinds of developing solution with different specific gravities can be measured in the same weight sensor unit 105.

The present disclosure relates to the subject matter contained in Japanese Patent Application No. 2005-145095, filed on May 18, 2005, which is expressly incorporated herein by reference in its entirety.

What is claimed is:

1. A liquid measuring device to detect an amount of liquid contained in a container, comprising:
a weight detecting system to detect weight of the container including the liquid contained in the container; and
an amount determining system configured to determine the amount of the liquid contained in the container based on the weight detected by the weight detecting system.

2. The liquid measuring device according to claim 1,
wherein the weight detecting system includes a guide member allowing the container to be shifted in vertical directions so that the container is restricted in moving in directions other than the vertical directions, and a weight sensor to resiliently hold the container and to sense the weight of the container including the liquid contained in the container.

3. A liquid containing unit comprising.
a liquid measuring device, which is adapted to detect an amount of liquid contained in a container, having a weight detecting system to detect weight of the container including the liquid contained in the container, and an amount determining system configured to determine the amount of the liquid contained in the container based on the weight detected by the weight detecting system.

4. The liquid containing unit according to claim 3,
wherein the weight detecting system includes a guide member allowing the container to be shifted in vertical directions so that the container is restricted in moving in directions other than the vertical directions, and a weight sensor to resiliently hold the container and to sense the weight of the container including the liquid contained in the container.

5. The liquid containing unit according to claim 4, further comprising a stirring system, which is adapted to stir the liquid contained in the container.

6. The liquid containing unit according to claim 5, wherein the stirring unit includes a screw to be rotated by a motor so that the liquid contained in the container is stirred thereby.

7. The liquid containing unit according to claim 6, wherein the stirring system is fixed to a mechanism being provided independently from the container.

8. The liquid containing unit according to claim 7, wherein the motor is activated at predetermined intervals.

9. The liquid containing unit according to claim 8, wherein the amount of the liquid contained in the container is detected whilst the motor is inactive.

10. The liquid containing unit according to claim 6, wherein the stirring system is located integrally with the container.

11. The liquid containing unit according to claim 10, wherein the amount of the liquid contained in the container is detected whilst the motor is active.

12. A wet type image forming apparatus, comprising:
a liquid measuring device to detect an amount of developing solution contained in a container, having a weight detecting system to detect weight of the container including the developing solution contained in the container, and an amount determining system configured to determine the amount of the liquid contained in the container based on the weight detected by the weight detecting system.

13. The wet type image forming apparatus according to claim 12,
wherein the weight detecting system includes a guide member allowing the container to be shifted in vertical directions so that the container is restricted in moving in directions other than the vertical directions, and a weight sensor to resiliently hold the container and to sense the weight of the container including the developing solution contained in the container.

14. A wet type image forming apparatus, comprising:
a liquid containing unit having a liquid measuring device, which is adapted to detect an amount of developing solution contained in a container and has a weight detecting system to detect weight of the container including the developing solution contained in the container, an amount determining system configured to determine the amount of the liquid contained in the container based on the weight detected by the weight detecting system.

15. The wet type image forming apparatus according to claim 14,
wherein the weight detecting system includes a guide member allowing the container to be shifted in vertical directions so that the container is restricted in moving in directions other than the vertical directions, and a weight sensor to resiliently hold the container and to sense the weight of the container including the developing solution contained in the container.

16. The wet type image forming apparatus according to claim 15,
wherein the liquid containing unit further includes a stirring system, which is adapted to stir the developing solution contained in the container.

17. The wet type image forming apparatus according to claim 16, wherein the stirring unit includes a screw to be rotated by a motor so that the developing solution contained in the container is stirred thereby.

18. The wet type image forming apparatus according to claim 17, wherein the stirring system is located integrally with the container.

19. The wet type image forming apparatus according to claim 18, wherein the amount of the liquid contained in the container is detected whilst the motor is active.

20. The wet type image forming apparatus according to claim 17, wherein the stirring system is fixed to a body of the wet type image forming apparatus independently from the container.

21. The wet type image forming apparatus according to claim 20, wherein the motor is activated at predetermined intervals.

22. The wet type image forming apparatus according to claim 21, wherein the amount of the developing solution contained in the container is detected whilst the motor is inactive.
